(19) United States
(12) Patent Application Publication
(10) Pub. No.: US 2026/0062105 A1
(43) Pub. Date: Mar. 5, 2026

(54) SUN CORAL NEUTRALIZATION AND COLLECTING APPARATUS AND METHOD

(71) Applicant: Oceaneering International, Inc., Houston, TX (US)

(72) Inventors: Yuri Coelho DEL'SARTO, RIO DE JANEIRO (BR); Rosianita BALENA, CURITIBA PARANÁ (BR)

(73) Assignee: Oceaneering International, Inc., Houston, TX (US)

(21) Appl. No.: 19/312,592

(22) Filed: Aug. 28, 2025

Related U.S. Application Data
(60) Provisional application No. 63/688,223, filed on Aug. 28, 2024.

(51) Int. Cl. B63G 8/00; A01K 74/00; B63G 8/38

(52) U.S. Cl. CPC B63G 8/001; A01K 74/00; B63G 8/38; B63G 2008/005

(57) ABSTRACT

Sun coral may be neutralized and collected using a sun coral neutralization and collecting system (1) of claim 1 by installing and attaching the sun coral neutralization and collecting system (1) proximate to a subsea structure; using the positioner (150) to move the sun coral neutralizer (100) along a surface of the subsea structure from a starting position along the subsea structure; neutralizing sun coral present proximate the surface of the subsea structure by energizing the heater (130) and using thermal energy supplied by the heater (130); and collecting neutralized sun coral using the collector to store the collected neutralized sun coral.

### CROSS-REFERENCE TO RELATED APPLICATIONS

This application claims priority through United States Provisional Application 63/688,223 filed on Aug. 28, 2024, incorporated herein by reference.

### BACKGROUND OF THE INVENTION

Sun coral (tubastraea coccinea, tubastraea tagusensis) is native species in some regions of the Pacific Ocean. Currently, it is considered as an invasive species in and along the Atlantic coast. For example, in Brazil sun coral was first observed in the late 1980s on oil platforms in the Campos Basin, in the north of the state of Rio de Janeiro, and in 1999 there was a record of oil platforms being completely taken over by sun coral. Sun coral colonies attached to offshore vessels and platform hulls increase its weight and drag forces and cause several drawbacks in offshore operations.

Currently, sun coral removal from subsea structures such as but not limited to vessel hulls is manually performed by divers. A floating unit needs to be relocated to sheltered waters to provide a safe environment for diving. The divers need to remove the coral and collect it, e.g., in baskets. Among the most relevant factors in the activity of manually removing invasive organisms in offshore structures is the risk to human health. Also, the manual removal operation is slow, onerous, and complex.

### BRIEF DESCRIPTION OF DRAWINGS

Various figures are included herein which illustrate aspects of embodiments of the disclosed inventions.

FIG. 1 is a view in partial perspective of an exemplary sun coral neutralizer;

FIG. 2 is an exploded view in partial perspective of an exemplary sun coral neutralizer;

FIG. 3 is a side view in partial perspective of an exemplary sun coral neutralizer;

FIG. 4 is a view in partial perspective illustrating an exemplary system controller;

FIG. 5 is a view in partial perspective of an exemplary neutralized sun coral collector;

FIG. 6 is a view in partial perspective of an exemplary neutralized sun coral collector and an associated remotely operated vehicle; and

FIG. 7 is a view in partial perspective of an exemplary system and subsea structure.

### DETAILED DESCRIPTION OF EMBODIMENTS OF THE INVENTION

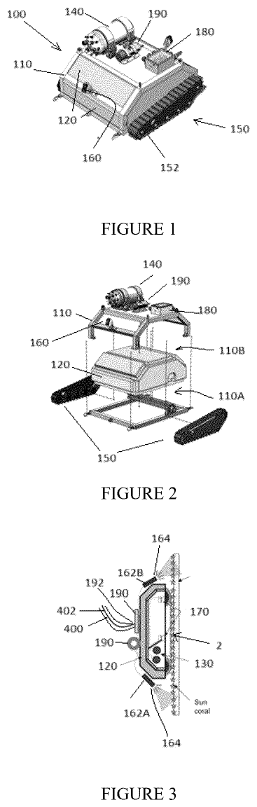

In a first embodiment, referring generally to FIG. 1, sun coral neutralization and collecting system 1 comprises sun coral neutralizer 100 and neutralized sun coral collector 200 (FIG. 5).

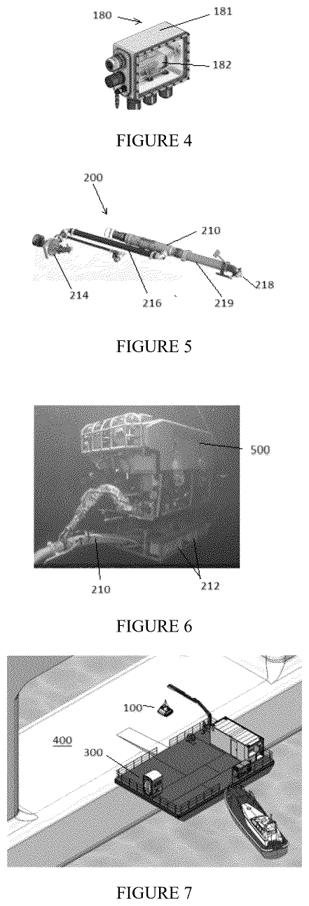

In embodiments, sun coral neutralizer 100 comprises rigidizer 110 configured to provide strength and robustness to sun coral neutralizer 100, rigidizer comprising interior 110A (FIG. 2) and exterior 110B (FIG. 2); thermal insulator 120 configured to reduce heat losses within a subsea environment and to adhere to a predetermined area about rigidizer 110; heater 130 (FIG. 3) configured to increase temperature of a proximate area comprising a predetermined control volume where heater 130 is disposed at least partially within rigidizer 110; one or more pressure vessels 140 disposed at a predetermined position of rigidizer 110, e.g., proximate an outside of rigidizer 110, and configured to provide housing for a predetermined set of electronic equipment; positioner 150 configured to position sun coral neutralizer 100 in or about a vessel or other structure subsea 400 (FIG. 7); visual inspector 160; a predetermined set of temperature sensors 170 (FIG. 3) configured to provide data representative of water temperature inside the controlled volume, e.g., interion 110B; system controller 180 comprising housing 181 (FIG. 4) with system controller processor 182 (FIG. 4) disposed at least partially within housing 181 and operatively in communication with heater 130, positioner 150, visual inspector 160, and the predetermined set of temperature sensors 170 and operative to control a predetermined set of functions of sun coral neutralizer 100 such as positioning, heating, and inspection; and power source 190 typically disposed at least partially within pressure vessel 140 and operatively connected to heater 130, positioner 150, visual inspector 160, and the predetermined set of temperature sensors 170.

As illustrated in FIG. 2, rigidizer 110 may comprise a substantially open framework or a more enclosed housing.

Positioner 150 typically comprises a predetermined set of crawlers 152 disposed about a predetermined outer boundary of rigidizer 110 and adapted to position sun coral neutralizer 100 at or proximate to subsea structure 400 (FIG. 7), e.g., a vessel hull. Crawlers 152 may comprise a propulsion crawler, a magnetic crawler, or both a propulsion crawler and a magnetic crawler, or the like.

Referring additionally to FIG. 3, visual inspector 160 may comprise one or more inspection cameras 162 configure to allow visual inspection of sun coral 2 both before and after heat treatment and lighting system 164 configured to provide sufficient light proximate inspection camera 162 to allow camera 162 to function. In embodiments, inspection camera may comprise first camera 162A disposed towards a first portion of rigidizer 110 on a first side of rigidizer 110, e.g., a front side, and second camera 162B disposed towards a second portion of rigidizer 110 on a second side of rigidizer 110, e.g., a rear side. In embodiments, lighting system 164 may comprise a light emitting diode configured to provide a visible field to inspection camera 162.

In most embodiments, power source 190 comprises an electrical power source and further comprises electrical connector 192 configured to interface with electrical conduit 402 in tether 400 and/or power system 194 disposed about or at least partially within rigidizer 110. Power system 194 may comprise one or more batteries which may be rechargeable.

The predetermined position of pressure vessel 140 may comprise a position on an outer surface of rigidizer 110 or at least partially within rigidizer 110.

Referring now to FIG. 5, neutralized sun coral collector 200 is configured to suction and collect neutralized sun coral 2 (FIG. 3) and may comprise one or more vacuum collectors 210, one or more containers 212 (FIG. 6) which may comprise one or more collector baskets to store neutralized sun coral, one or more subsea pumps 214 configured to provide positive pressure, one or more movable sleeves 216 configured to carry neutralized sun coral to containers 212, at least one end effector 218 configured to attach to subsea structure 400 (FIG. 7), e.g., a vessel hull, and collect sun coral 2 (FIG. 3), and filter 219 which is typically configured to segregate elements of a predetermined size.

Vacuum collector 210 typically comprises a venturi system to provide suction.

In certain embodiments, referring to FIG. 7, control van 300 may be present and operatively in communication with system controller 180 (FIG. 1) to provide a safe environment to control sun coral neutralization and collecting system 1.

In the operation of exemplary methods, referring back to FIG. 1, sun coral may be removed in two steps using sun coral neutralization and collecting system 1: sun coral neutralization, typically by using thermal energy, by isolating and heating proximate sea water and increasing water temperature increase using heater 130, and sun coral collection and extraction, typically by using a dredge tool (not shown in the figures) and neutralized sun coral collector 200 to store the sun coral to be removed. Typically, inspection and neutralization utilize sun coral neutralizer 100 and suction and extraction of neutralized sun coral utilizes neutralized sun coral collector 200.

Sun coral may be neutralized and collected using sun coral neutralization and collecting system 1 as described herein by installing sun coral neutralization and collecting system 1 proximate subsea structure 400 and attaching sun coral neutralization and collecting system 1 to subsea structure 400. Once sun coral neutralization and collecting system 1 is installed proximate subsea structure 400, sun coral neutralizer 100 may be used to inspect, locate, and neutralize sun coral 2. In embodiments, installing sun coral neutralization and collecting system 1 comprises making sun coral neutralization and collecting system 1 permanently resident with respect to subsea structure 400.

Once attached, positioner 150 is used to position and move sun coral neutralizer 100 along a predetermined surface of subsea structure 400 from a starting position along subsea structure 400, e.g., outside subsea structure 400. At a predetermined time, sun coral 2 present proximate the surface of subsea structure 400 may be neutralized by energizing heater 130 and using thermal energy supplied by heater 130 such as to heat sea water present in or near interior 110B. In contemplated embodiments, sun coral neutralizer 100 can operate with a maximum heating temperature of 100° C. in a maximum water depth of 50 meters. Once neutralized, neutralized sun coral may be and collected using neutralized sun coral collector 200 to store the collected neutralized sun coral 2.

Energizing heater 130 and using thermal energy supplied by heater 130 further may further comprise isolating and heating sea water proximate heater 130 using heater 130 such as by increasing water temperature using underwater thermal resistances, e.g., an electric heater 130 through heat joule effects.

In embodiments, remotely operated vehicle (ROV) 500 may be used to install sun coral neutralization and collecting system 1 proximate subsea structure 400.

The disclosed invention eliminates the necessity of divers in sun coral removal operations, reduces risks to humans working in an underwater environment reduces contamination risks since the operation will first neutralize sun coral, reduces the requirements for filtering the material removed since the operation will first neutralize sun coral, and, in embodiments, may be automated to perform periodic sun coral cleaning operation The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1) A sun coral neutralization and collecting system, comprising:
a) a sun coral neutralizer, comprising:
i) a rigidizer comprising an exterior and an interior;
ii) a thermal insulator configured to adhere to a predetermined area about the exterior of the rigidizer;
iii) a heater disposed at least partially within the rigidizer;
iv) a pressure vessel disposed at a predetermined position of the rigidizer;
v) a positioner;
vi) a visual inspector;
vii) a predetermined set of temperature sensors;
viii) a system controller disposed at a predetermined position of the pressure vessel and operatively in communication with the heater, the positioner, the visual inspector, and the predetermined set of temperature sensors, the system controller operative to control a predetermined sun coral neutralizer functions; and
ix) a power source disposed at a predetermined position of the pressure vessel and operatively connected to the heater, the positioner, the visual inspector, and the predetermined set of temperature sensors; and
b) a neutralized sun coral collector.

2) The sun coral neutralization and collecting system of claim 1 further comprising a control van operatively in communicate with the sun coral neutralization and collecting system.

3) The sun coral neutralization and collecting system of claim 1, wherein the positioner comprises a predetermined set of crawlers disposed about a predetermined outer boundary of the rigidizer and adapted to position the sun coral neutralizer at a subsea structure.

4) The sun coral neutralization and collecting system of claim 3, wherein the positioner crawlers comprise a propulsion crawler, a magnetic crawler, or both a propulsion crawler and a magnetic crawler.

5) The sun coral neutralization and collecting system of claim 1, wherein the visual inspector further comprises:
a) an inspection camera; and
b) a lighting system.

6) The sun coral neutralization and collecting system of claim 5, wherein the inspection camera comprises:
a) a first camera disposed towards a first portion of the rigidizer on a first side of the rigidizer;
and
b) a second camera disposed towards a second portion of the rigidizer on a second side of the rigidizer.

7) The sun coral neutralization and collecting system of claim 6, wherein the lighting system comprises a light emitting diode configured to provide a visible field to the inspection camera.

8) The sun coral neutralization and collecting system of claim 1, wherein the power source comprises an electrical power source and further comprises:
a) an electrical connector configured to interface with an electrical conduit disposed in a tether; and
b) a power system disposed at least partially within the rigidizer.

9) The sun coral neutralization and collecting system of claim 1, wherein the predetermined position of the pressure vessel comprises a position on an outer surface of the rigidizer or at least partially within the rigidizer.

10) The sun coral neutralization and collecting system of claim 1, wherein the sun coral collector comprises:
a) a vacuum collector;
b) a container;
c) a subsea pump;
d) a movable sleeve;
e) an end effector; and
f) a filter.

11) The sun coral neutralization and collecting system of claim 10, wherein the vacuum collector further comprises a venturi system to provide suction.

12) A method of sun coral neutralization and collecting using a sun coral neutralization and collecting system comprising a sun coral neutralizer comprising a rigidizer comprising an exterior and an interior; a thermal insulator configured to adhere to a predetermined area about the exterior of the rigidizer; a heater disposed at least partially within the rigidizer; a pressure vessel disposed at a predetermined position of the rigidizer; a positioner; a visual inspector; a predetermined set of temperature sensors; a system controller disposed at a predetermined position of the pressure vessel and operatively in communication with the heater, the positioner, the visual inspector, and the predetermined set of temperature sensors, the system controller operative to control a predetermined sun coral neutralizer functions; and a power source disposed at a predetermined position of the pressure vessel and operatively connected to the heater, the positioner, the visual inspector, and the predetermined set of temperature sensors; and a neutralized sun coral collector, the method comprising:
a) installing the sun coral neutralization and collecting system proximate a subsea structure;
b) attaching the sun coral neutralization and collecting system to the subsea structure;
c) using the positioner to move the sun coral neutralizer along a surface of the subsea structure from a starting position along the subsea structure;
d) at a predetermined set of time, neutralizing a sun coral present proximate the surface of the subsea structure by energizing the heater and using thermal energy supplied by the heater;
and
e) collecting neutralized sun coral using the collector to store the collected neutralized sun coral.

13) The method of claim 12, wherein using thermal energy supplied by the heater further comprises isolating and heating sea water proximate the heater using the heater.

14) The method of claim 13, wherein energizing the heater and using thermal energy supplied by the heater further comprises increasing water temperature proximate the heater using underwater thermal resistances through heat joule effects.

15) The method of claim 12, further comprising using a remotely operated vehicle (ROV) to install the sun coral neutralization and collecting system proximate the subsea structure.

16) The method of claim 12, further comprising using the neutralization module to inspect, locate, and neutralize sun coral once the sun coral neutralization and collecting system is installed proximate the subsea structure.

17) The method of claim 12, wherein installing the sun coral neutralization and collecting system comprises making the sun coral neutralization and collecting system permanently resident with respect to the subsea structure.
